(19) United States
(12) Patent Application Publication
(10) Pub. No.: US 2026/0304417 A1
(43) Pub. Date: Oct. 1, 2026

(54) SYSTEMS AND METHODS FOR ADAPTIVE UPLINK GRANTS IN RADIO ACCESS NETWORKS

(71) Applicant: Verizon Patent and Licensing Inc., Basking Ridge, NJ (US)

(72) Inventors: Shuang Echo Yang, Naperville, IL (US); Susan Wu Sanders, Bridgewater, NJ (US); Xin Wang, Morris Plains, NJ (US); Cindy Yuexin Dong, Bridgewater, NJ (US)

(21) Appl. No.: 19/095,245

(22) Filed: Mar. 31, 2025

(51) Int. Cl. H04W 72/1268; H04W 24/02; H04W 72/115

(52) U.S. Cl. CPC H04W 72/1268; H04W 24/02; H04W 72/115

(57) ABSTRACT

A method, a network device, and a non-transitory computer-readable storage medium are described in relation to an adaptive UL grant service. The service assigns a latency sensitivity priority score for a user device based on the model and identifies a radio frequency (RF) condition for the user device. The service also adds the user device to a pool for advanced uplink (UL) grants based on the latency sensitivity priority score, when the identified RF conditions are above an RF condition threshold. The service assigns prior to receiving a scheduling request from the user device, UL grant properties for the user device in the pool based on a predicted traffic pattern from the model.

### BACKGROUND

Development and design of networks create new service opportunities from a network-side perspective and an end device perspective. With respect to Next Generation (NG) wireless networks, such as Fifth Generation New Radio (5G NR) networks, various mechanisms and technologies may be used to ensure the delivery of certain performance metrics, such as low latency, high throughput, and other types of network performance criteria. Efficient scheduling of resources for low latency communications can present unique challenges.

### BRIEF DESCRIPTION OF THE DRAWINGS

FIGS. 1A-1D illustrate concepts described herein;

FIG. 2 is a diagram illustrating an exemplary environment in which an embodiment of an adaptive UL grant service may be implemented;

FIG. 3 is a diagram illustrating an architecture for adaptive UL grants based on artificial intelligence (AI)/machine learning (ML), according to an implementation;

FIG. 4is a diagram illustrating communication among network devices to implement modeling for the adaptive UL grant service;

FIG. 5 is a diagram illustrating an exemplary process of an embodiment of the adaptive UL grant service;

FIG. 6 is a diagram illustrating components of a device that may correspond to one or more of the devices illustrated and described herein; and

FIG. 7 is a flow diagram illustrating an exemplary process of another embodiment of the adaptive UL grant service.

### DETAILED DESCRIPTION

The following detailed description refers to the accompanying drawings. The same reference numbers in different drawings may identify the same or similar elements. Also, the following detailed description does not limit the invention.

In wireless networks, such as a 5G NR network, determining how the network grants uplink (UL) resources efficiently can be a challenge. Traditionally, a wireless access station (e.g., a Next Generation Node B or gNB) for a Radio Access Network (RAN) can dynamically give grants based on a user’s data demands. However, this dynamic UL grant allocation takes time for a user to send signal reports, receive the UL grants, and then transfer UL traffic after grants are received. Thus, dynamic UL grants may not be optimal for latency-sensitive users.

To address latency-sensitive services, pre-scheduling and/or UL configured grants may be used to pre-grant fixed resources (e.g., a slot and physical resource block (PRB), as well as a modulation and coding scheme (MCS), etc.) to a certain service and/or device group.

Both pre-scheduling and UL configured grants (referred to herein collectively as "UL pre-grants") allocate UL resources prior to receiving scheduling requests (SR) from a user. Pre-scheduling may allocate estimated UL resources needed by an end device. UL configured grants may provide fixed periodicity and time slots for any UL traffic. Although UL pre-grants may help resolve latency issues, network efficiency is reduced, as some of the grants could be unused or underused by the user. On the other hand, UL pre-grants may provide little benefit to the latency issue when the user demand is frequently bigger than the fixed size of the UL pre-grant, as continual segmentation can also increase latency. Furthermore, UL pre-grants may prove inefficient when poor radio frequency (RF) conditions cannot support the UL pre-grant schemas.

Systems and methods described herein provide an adaptive UL grant service. The adaptive UL grant service may learn the latency behavior of users and give a predicted score, referred to herein as a latency sensitivity priority score. Based on the latency sensitivity priority score, the adaptive UL grant service may prioritize users that can best benefit from UL pre-grants. For example, for user data patterns with more periodicity, the adaptive UL grant service may assign UL configured grants, while for user data patterns with less periodicity, the adaptive UL grant service may assign pre-scheduling. Lower scoring users that do not quality for UL pre-grants (e.g., based on poor signal quality or predicted traffic patterns) may be designated for dynamic scheduling grants.

According to an implementation, AI/ML models may be trained to optimize the pre-scheduling and UL configured grants for high scoring users. For example, an optimization engine may adjust the UL configure grant and pre-scheduling properties for the selected latency-sensitive users. The optimization engine may adjust UL grant size and number of PRBs based on the user’s predicted burst size, adjust the MCS being used based on the user’s RF condition; and/or adjust grant periodicity and offset based on predicted grant-to-data-arrival times.

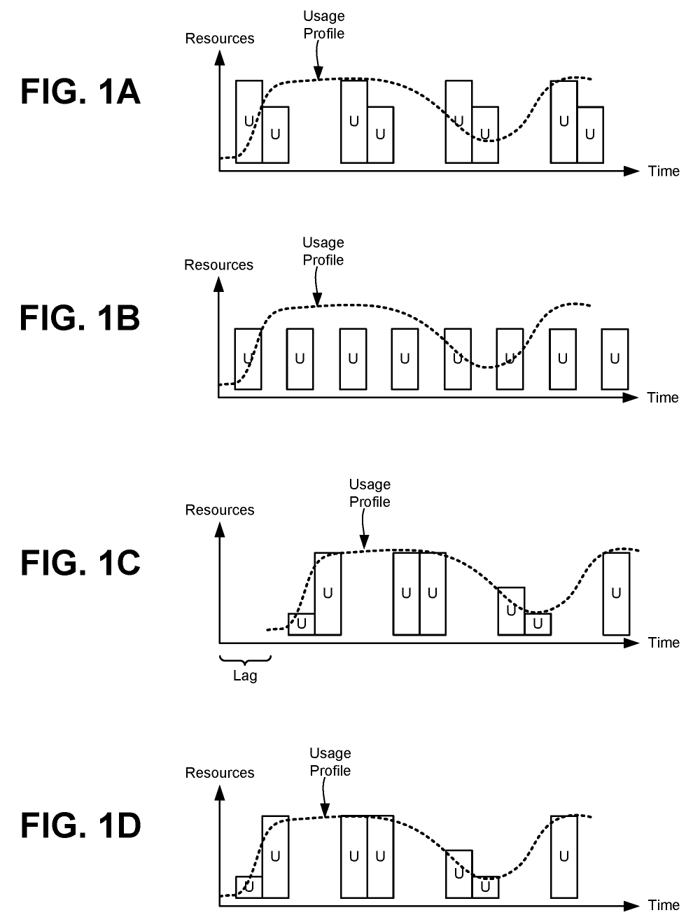

FIGS. 1A-1D illustrate concepts described here. FIG. 1A is a schematic illustrating pre-scheduling. FIG. 1B is a schematic illustrating UL configured grants. FIG. 1C is a schematic illustrating dynamic grants. FIG. 1D is a schematic illustrating a pre-scheduling adaptation.

Referring to FIG. 1A, a wireless access station, such as a gNB, may provide pre-scheduling grants to a user device, where the gNB allocates Physical Uplink Shared Channel (PUSCH) resources in advance, without receiving any scheduling requests (SR) or buffer state reports (BSR) from the user device. With pre-scheduling, a user device can respond very quickly when data transmission starts without any needed signaling for the PUSCH allocation. However, the allocation may not correspond well to the actual usage demand of the user device, resulting in wasted resources and/or segmentation.

Referring to FIG. 1B, the wireless access station may provide UL configured grants to a user device, where the gNB permits data transmission without resource request using a standardized configuration scheme (e.g., configured grant Type 1 or Type 2). The UL configured grants may provide fixed periodicity and time slots for UL data. However, the configured grants may not provide optimal use of physical resources and/or may not effectively support data bursts.

Referring to FIG. 1C, dynamic grants may use a scheduling request and/or other user data to closely track a usage profile. Thus, dynamic resource scheduling may provide an efficient use of physical resources. However, the signal exchange to submit the scheduling request to a wireless access station and receive a UL grant from the wireless access station may create an undesirable lag or latency, which may be unacceptable for some applications or service types. When the network is in a congestion situation, a dynamic grant may be preferred to maximize network spectrum efficiency.

Referring to FIG. 1D, a UL pre-grant (either of a UL configured grant or pre-scheduling grant) may be adapted to reflect a predicted usage profile. For example, as shown in FIG. 1D, an AI/ML system in conjunction with a wireless access station may adjust pre-scheduling to more closely match a usage profile based on known/learned data patterns of, for example, applications and/or services used by a particular user device. In a similar manner (not shown), a UL configured grant may be adjusted to match a PRB size and periodicity for different applications and/or services used by a particular user device. In one implementation, an adapted pre-scheduling grant or an adapted UL configured grant may be optimized to match the efficiency of dynamic grants without the lag associated with dynamic grants. In another implementation, an adapted UL configured grant may be optimized for a required size and periodicity while limiting the number of unused/underused UL slots.

According to implementations described herein, the adaptive UL grant service may select among the scheduling types referred to in FIGS. 1A-1D, based on available inputs for individual users. For example, the adaptive UL grant service may monitor user traffic patterns, user RF conditions, data timing (e.g., grant to data arrival timing), and network conditions, among other indicators, to optimize UL scheduling for 5G NR connections. In one implementation, an AI/ML optimization engine may provide inference models that can be applied by a wireless access station (e.g., a gNB). In another implementation, a grid/table of settings for UL configured grants can be used to match different UL grant settings to different applications or services.

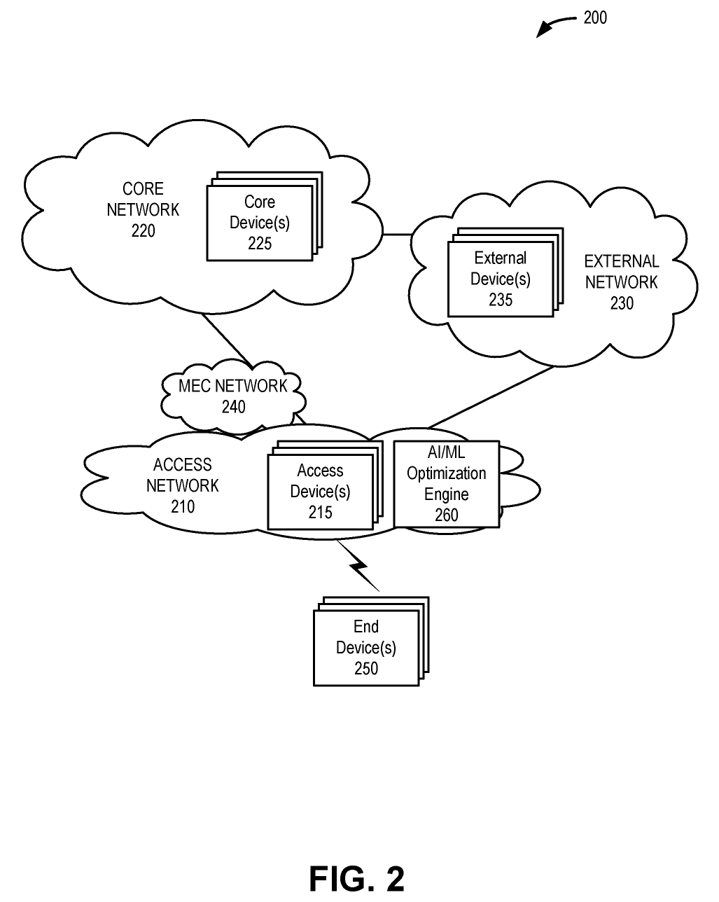

FIG. 2 is a diagram illustrating an environment 200 in which an exemplary embodiment of an adaptive UL grant service may be implemented. As illustrated, environment 200 includes an access network 210, a core network 220, and an external network 230. Access network 210 includes access devices 215 (also referred to individually or generally as access device 215), which may correspond to the wireless access station described above in connection with FIGS. 1A-1D. Core network 220 includes core devices 225 (also referred to individually or generally as core device 225). External network 230 includes external devices 235 (also referred to individually or generally as external device 235). Environment 200 may further include a Multi-access Edge Computing (MEC) network 240 (also referred to as a mobile edge computing network), end devices 250 (also referred to individually or generally as end device 250), and an artificial intelligence (AI)/machine learning (ML) optimization engine 260.

The number, type, and arrangement of networks illustrated in environment 200 are exemplary. For example, according to other embodiments, environment 200 may include fewer networks, additional networks, and/or different networks. For example, according to other embodiments, other networks not illustrated in FIG. 2 may be included, such as an X-haul network (e.g., backhaul, mid-haul, fronthaul, etc.), a transport network, or another type of network that may support a wireless service and/or an end device application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 200 includes communication links between the networks and between the network devices. Environment 200 may be implemented to include wired, optical, and/or wireless communication links. A communicative connection via a communication link may be direct or indirect. For example, an indirect communicative connection may involve an intermediary device and/or an intermediary network not illustrated in FIG. 2. A direct communicative connection may not involve an intermediary device and/or an intermediary network. The number, type, and arrangement of communication links illustrated in environment 200 are exemplary.

Environment 200 may include various planes of communication including, for example, a control plane (CP), a user plane (UP), a service plane, and a network management plane. Environment 200 may include other types of planes of communication. A message communicated in support of the adaptive UL grant service may use at least one of these planes of communication. According to various exemplary implementations, the interface of the network device may be a service-based interface, a reference point-based interface, an Open Radio Access Network (O-RAN) interface, a 5G interface, another generation of interface (e.g., 5G Advanced, Sixth Generation (6G), Seventh Generation (7G), etc.), or some other type of network interface (e.g., proprietary, etc.).

Access network 210 may include one or multiple networks of one or multiple types and technologies. For example, access network 210 may be implemented to include a 5G RAN, a future generation RAN (e.g., a 6G RAN, a 7G RAN, etc.), a centralized-RAN (C-RAN), a virtualized RAN (vRAN), an Open-RAN (O-RAN), and/or another type of access network. Access network 210 may include a legacy RAN (e.g., a Third Generation (3G) RAN, a Fourth Generation (4G) RAN, etc.). Access network 210 may communicate with and/or include other types of access networks, such as, for example, a Wi-Fi® network, a local area network (LAN), a Citizens Broadband Radio System (CBRS) network, a cloud RAN, a self-organizing network (SON), a wired network (e.g., optical, cable, etc.), or another type of network that provides access to or can be used as an on-ramp to access network 210 and/or core network 220.

Access network 210 may include different and multiple functional splitting, such as options 1, 2, 3, 4, 5, 6, 7, or 8 that relate to combinations of access network 210 and core network 220 including an Evolved Packet Core (EPC) network and/or a Next Generation Core (NGC)/5G core network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., N2, N3, F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (CoMP), various duplex schemes (e.g., frequency division duplex (FDD), time division duplex (TDD), half-duplex FDD (H-FDD), etc.), and/or another type of connectivity service (e.g., NSA NR, SA NR, etc.). Additionally, or alternatively, according to some exemplary embodiments, access network 210 may be implemented to include various wired and/or optical architectures for wired and/or optical access services.

Depending on the implementation, access network 210 may include one or multiple types of network devices, such as access devices 215. For example, access device 215 may include a gNB, an enhanced LTE (eLTE) evolved Node B (eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN gNB, O-RAN-eNB), a 5G ultra-wide band (UWB) node, and/or a future generation wireless access device (e.g., a 5G advanced wireless station, a 6G wireless station, a 7G wireless station, or another generation of wireless station). Access devices 215 may include a transport device (e.g., a router or similar network device).

Access device 215 may include other types of wireless access devices, such as a Wi-Fi device, a hotspot device, and/or a fixed wireless access customer premise equipment (FWA CPE), etc.) that provides a wireless access service. Additionally, access devices 215 may include a wired and/or an optical device (e.g., modem, wired access point, optical access point, Ethernet device, multiplexer, etc.) that provides network access and/or transport service. According to some exemplary implementations, access device 215 may include a combined functionality of multiple RATs (e.g., 4G and 5G functionality, 5G and 5G Advanced functionality, 5G and 6G), etc.) via soft and hard bonding based on demands and needs. According to some exemplary implementations, access device 215 may include a split access device (e.g., a CU-control plane (CP), a CU-user plane (UP), etc.) or an integrated functionality, such as a CU-CP and a CU-UP, or other integrations of split RAN nodes. Access device 215 may be an indoor device or an outdoor device.

According to various exemplary implementations, access device 215 may include one or multiple sectors or antennas. The antenna may be implemented according to various configurations, such as single input single output (SISO), single input multiple output (SIMO), multiple input single output (MISO), multiple input multiple output (MIMO), massive MIMO, three dimensional (3D) and adaptive beamforming (also known as full-dimensional agile MIMO), two dimensional (2D) beamforming, antenna spacing, tilt (relative to the ground), radiation pattern, directivity, elevation, planar arrays, and so forth. Depending on the implementation, access device 215 may provide a wireless access service at a cell, a sector, a sub-sector/zone, carrier, and/or other configurable level.

According to some exemplary embodiments, at least some of access devices 215, as described herein, include an embodiment of the adaptive UL grant service. For example, according to an exemplary embodiment, a CU, a RIC, or similar type of wireless station controller device may include logic of the adaptive UL grant service. According to such an embodiment, the CU, RIC, or the like may generate and provide UL grant scheduling models (e.g., inference models) to another access device 215 (e.g., a DU, wireless station, or the like), as described herein. According to one implementation, AI/ML optimization engine 260 may be included in access network 210.

Core network 220 may include one or multiple networks of one or multiple network types and technologies. Core network 220 may include a complementary network of access network 210. For example, core network 220 may be implemented to include a 5G core network, an evolved packet core (EPC) of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation, core network 220 may include diverse types of core devices 225. Core devices 225 may include, for example, a user plane function (UPF), a Non-3GPP Interworking Function (N3IWF), an access and mobility management function (AMF), a session management function (SMF), a unified data management (UDM) device, a unified data repository (UDR), an authentication server function (AUSF), a security anchor function (SEAF), a network slice selection function (NSSF), a network repository function (NRF), a policy control function (PCF), a network data analytics function (NWDAF), and/or a network exposure function (NEF). According to one implementation, AI/ML optimization engine 260 may be included in core network 220. According to other exemplary implementations, core devices 225 may include additional, different, and/or fewer network devices than those described.

External network 230 may include one or multiple networks of one or multiple types and technologies that provide an application service. For example, external network 230 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 230 may be implemented to include a cloud network, a private network, a public network, a MEC network, a fog network, the Internet, a packet data network (PDN), a service provider network, the World Wide Web (WWW), an Internet Protocol Multimedia Subsystem (IMS) network, a Rich Communication Service (RCS) network, a software-defined (SD) network, a virtual network, a packet-switched network, a data center, a data network, or other type of application service layer network that may provide access to and may host an end device application service.

Depending on the implementation, external network 230 may include various network devices, such as external devices 235. For example, external devices 235 may include virtual network devices (e.g., virtualized network functions (VNFs), servers, host devices, application functions (AFs), application servers (ASs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by end devices 250. By way of further example, external devices 235 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). Although not illustrated, external network 230 may include one or multiple types of core devices 225, as described herein.

External devices 235 may host one or multiple types of application services. For example, the application services may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, and/or other types of wireless and/or wired application services.

MEC network 240 may be associated with access network 210 and may provide MEC services for end devices 250 attached to access devices 215. MEC network 240 may be in proximity to access devices 215 from a geographic and network topology perspective, thus enabling low latency services to be provided to end devices 250. As an example, MEC network 240 may be located on the same site as a gNB. As another example, MEC network 240 may be geographically closer to one of access devices 215 and reachable via fewer network hops and/or fewer switches, than other macro cell access devices 215.

End device 250 may include a device that may have communication capabilities (e.g., wireless, wired, optical, etc.). End device 250 may or may not have computational capabilities. End device 250 may be implemented as a mobile device, a portable device, a stationary device (e.g., a non-mobile device and/or a non-portable device), a device operated by a user, or a device not operated by a user. For example, end device 250 may be implemented as a smartphone, a mobile phone, a personal digital assistant, a tablet, a netbook, a wearable device (e.g., a watch, glasses, headgear, a band, etc.), a computer, a gaming device, a music device, an IoT device, a drone, a smart device, an autonomous vehicle, or another type of wireless device (e.g., another type of user equipment (UE)). End device 250 may or may not be configured to execute diverse types of software (e.g., applications, programs, etc.). The number and the types of software may vary among end devices 250. End device 250 may include “edge-aware” and/or “edge-unaware” application service clients. End device 250 may be implemented as a virtualized device in whole or in part. For purposes of description, end device 250 is not considered a network device.

As further shown in FIG. 2, AI/ML optimization engine 260 may be included in access network 210. One or more aspects of AI/ML optimization engine 260 may be implemented, for example, by an access device 215 (e.g., a RIC device, a BSC, a gNB, and/or a split access device). According to an exemplary embodiment, at least some of access devices 215 may include logic of an exemplary embodiment of the adaptive UL grant service. For example, a RIC, an RNC, a BSC, or similar type of network device that may manage, control, and/or configure a cellular wireless station of access network 210 may provide the aspects of the adaptive UL grant service. According to an exemplary embodiment, AI/ML optimization engine 260 may generate, provide, and/or update inference models that can be applied by a scheduler of am access device 215 (e.g., gNB or DU).

According to an exemplary embodiment, at least some other access devices 215 may include logic of an exemplary embodiment of the adaptive UL grant service. For example, a gNB, an eNB, or another type of wireless station may provide aspects of the adaptive UL grant service. In one implementation, a model training function may reside in a non-real time (RT) RIC (e.g., in a Service Management and Orchestration (SMO) framework) and an inference model function may reside in a CU, DU, or a near-RT RIC.

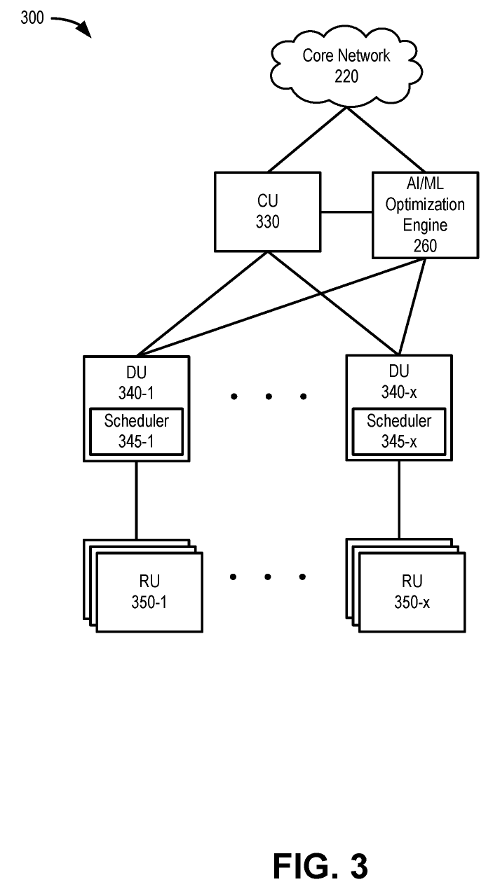

FIG. 3 is a diagram illustrating an exemplary portion 300 of environment 200 that may be used with the adaptive UL grant service. As shown in FIG. 3, portion 300 may include a CU 330, DUs 340-1 through 340-x (also referred to collectively as DUs 340 and individually as DU 340), RU groups 350-1 through 350-x (also referred to collectively as RUs 350 and individually as RU 350), core network 220, and AI/ML optimization engine 260. Each of DUs 340 may include a corresponding scheduler 345-1 through 345-x (referred to collectively as schedulers 345 and individually as scheduler 345). AI/ML optimization engine 260 may be part of a RIC system, CU 330, or similar type of RAN controller device that uses AI-enabled policies and ML-based models to optimize network performance. According to implementations described herein, AI/ML optimization engine 260 may perform AI/ML-based modeling for the adaptive UL grant service.

Devices (e.g., core devices 225) in core network 220 may perform UE-based authentication, authorization, and mobility management for end devices 250. In relation to the adaptive UL grant service, core network 220 may identify end device types, applications, and other profile information, associated with connected end devices 250 that may be applied by CU 330 and/or DUs 340 to implement an inference model for the adaptive UL grant service (e.g., a model trained and provided by AI/ML optimization engine 260).

CU 330 may include a central unit for a gNB or another access device 215. In one implementation, CU 330 may conform to standards for an O-CU. CU 330 may control the transport of data (e.g., data packets) received via wireless RF transmissions from an end device 250 and may control the transport of data from a wireless network to a DU 340 for wireless transmission (e.g., via RUs 350) to a destination end device 250. CU 330 may be associated with multiple DUs 340. In some implementations, CU 330 may be divided into control plane (CP) and user plane (UP) components. The CU-CP includes a logical node that hosts Radio Resource Control (RRC) and other control plane functions (e.g., Service Data Adaptation Protocol (SDAP), Packet Data Convergence Protocol (PDCP), etc.). The CU-UP includes a logical node that hosts user plane functions, such as, for example, data routing and transport functions. In relation to the adaptive UL grant service, CU 330 may identify current RF conditions for an end device 250, such as signal quality measurement information that indicates a particular signal quality, as well as grant to data arrival timing. For example, RF conditions may be implied or derived based on current (real-time) signal measurements from a connected end device 250, signal measurements by other end devices 250, or based on known signal propagation models.

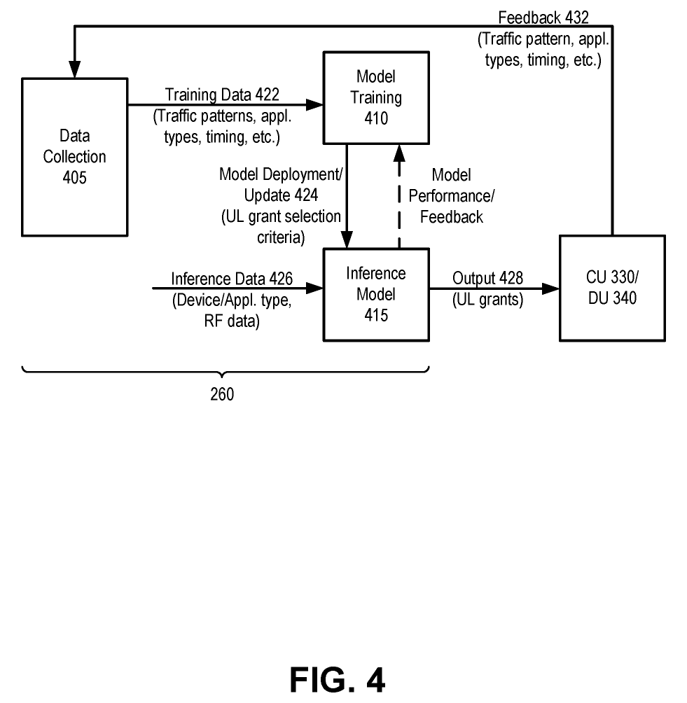

DU 340 may include, in some implementations, a logical node that hosts functions associated with the Radio Link Control layer, the Medium Access Control (MAC) layer, and the physical layer (PHY). For example, DU 240 may conform to standards for an O-DU. In some implementations, the DU 340 may host scheduler 345 for managing use of physical resources for uplink and downlink signaling over a corresponding group of RUs 350. DU 340 may perform one or more aspects relating to the adaptive UL grant service, such as functions described above in connection with CU 330. In one implementation, DU 340 may also facilitate AI/ML model online training, such as model training described below in connection with FIG. 4.

Scheduler 345 may schedule use of resources (e.g., resource blocks in a physical layer) to optimize delivery of UL/DL traffic for end devices 250. According to one implementation, scheduler 345 prioritize users and apply an inference model or a grant matrix to perform UL scheduling based on one of dynamic grants, UL configured grants, or pre-scheduling. For example, under direction of CU 330 or AI/ML optimization engine 260, scheduler 345 may apply an inference model to prioritize users (e.g., end devices 250) based on latency sensitivity, as described further herein. Scheduler 345 may distinguish, for example, between low priority and high priority latency-sensitive users by associating a user with a latency sensitivity priority score. In one implementation, scheduler 345 may use dynamic grants to assign UL resources to users with low priority score. For high priority users, scheduler 345 may use UL pre-grants (e.g., either UL configured grants or pre-scheduling) to assign UL resources, where the UL configured grants or pre-scheduling may be fine-tuned for predicted traffic patterns based on the inference model. In still other implementations, scheduler 345 may apply a grid matrix that does not rely on AI/ML optimization engine 260, but instead associates particular applications/services with different traffic patterns and priorities. In the case of a stored grid, for example, DU 340 may also use preconfigured settings according to predefined services based on a PLMN, radio access technology (RAT)-type, RAT frequency selection priority (RFSP)/subscriber profiling identity (SPID), Single Network Slice Selection Assistance Identifier (S-NSSAI), QCI/5QI, and/or any combination of these.

FIG. 4 illustrates an example of a functional framework of the adaptive UL grant service for generating and applying UL scheduling models (e.g., inference models). The framework of the adaptive UL grant service may be included, for example, within a portion of access network 210, such as a non-RT RIC or CU 330, or core network 220. In one implementation, the adaptive UL grant service may be distributed among one or more access devices 215.

As shown in FIG. 4, a data collection component 405 may receive and store data relevant to a particular machine learning objective, such as end device history info to support the adaptive UL grant service. Data collection component 405 may provide a predetermined data set (e.g., training data 422) for model training 410. For the adaptive UL grant service, collected training data may include, for example, traffic patterns associated with particular applications, application types, and/or device types; RF conditions during UL signaling; and/or grant-to-data-arrival timing (e.g., time from sending the UL grants to data arrival at the access station).

Model training 410 may use a deep neural network to learn how to analyze the training data and make inferences, such as inferences for adaptive UL grants. In some implementations, one or more components of inference model 415 may include machine learning models, such as a deep learning neural network and/or another type of neural network. Inference model 415 may include multiple layers of nodes (or neurons) with a certain arrangement of connections between the nodes. Weights (i.e., numerical values) may be associated with the connections between the nodes. Each connection between nodes may have an associated weight that signifies a strength and direction (e.g., positive or negative) of the influence one node has on another. In other implementations, inference model 415 may include a K-nearest neighbors (KNN) classifier, a decision tree classifier, a naïve Bayes classifier, a support vector machine (SVM) classifier, tree based (e.g., a random forest) classifier using Euclidian and/or cosine distance methods, a logistic regression classifier, a linear discriminant analysis classifier, a quadratic linear discriminant analysis classifier, a maximum entropy classifier, a kernel density estimation classifier, a principal component analysis (PCA) classifier, a gradient boosting framework (e.g. XGBoost, LightGBM) and/or another type of classifier. Other configurations may be implemented.

Model training 410 may eventually generate an inference model 415 for deployment (e.g., model deployment/update 424) in the adaptive UL grant service (e.g., to be applied by scheduler 345). Inference model 415 may associate, for example, device types and/or application types with particular UL grant patterns. UL grant patterns may include selection criteria and parameters for using pre-scheduling (e.g., transport block size, PRBs, periodicity, etc.), selection criteria and parameters for using UL configured grants (e.g., transport block size, an MCS table, periodicity/offset values, etc.), and/or selection criteria for using dynamic grants.

New data (e.g., inference data 426) for the adaptive UL grant service may be applied to inference model 415. For example, inference data may include a device type, an application type, and RF condition data for new session/connection requests from end devices 250. The device type may include, for example, a unique identifier for an end device 250 (e.g., a mobile station ID (MSID), a mobile directory number (MDN), or an international mobile subscriber identity (IMSI) of the end device). The application type may include a direct application identifier (e.g., a server ID or application type ID) or an indirect application identifier, such as a network slice type, a 5G QoS Identifier (5QI), a QoS Class Identifier (QCI), or the like, associated with the end device session. The RF condition may include any of several signal quality parameters for a particular end device 250 being served by access device 215, a variation in the channel quality measured by the particular end device 250, such as a channel quality indicator (CQI) value, a signal to noise ratio (SNR) value, a signal-to-interference-plus-noise ratio (SINR) value, a block error rate (BLER) value, a Received Signal Strength Indication (RSSI) value, a Reference Signal Received Quality (RSRQ) value, a Reference Signal Received Power (RSRP) value, and/or another measure of signal strength or quality. According to an implementation, an RF condition threshold may be associated with a limit for any of the above RF conditions.

Inference model 415 may receive inference data 426 as input and provide an output 428 to CU 330/DU 340. Output 428 may include, for example, UL configuration grant parameters or pre-scheduling grant parameters associated with different end device types and/or application types. Output 428 may be received by a CU 330/DU 340 (e.g., a network actor), which may apply the output to manage UL grant scheduling. CU 330/DU 340 may provide feedback 432, such as application types, traffic patterns, RF conditions, grant-to-data-arrival timing, etc., to data collection component 405 to indicate, for example, the accuracy and/or effectiveness of output 428.

While FIG. 4 illustrates an example arrangement of components for AI/ML optimization engine 260, in other implementations, components of AI/ML optimization engine 260 may be arranged differently. For example, in another implementation, model training 410 may reside in a CU 330, while inference model 415 may reside in DU 340 or a near-RT RIC.

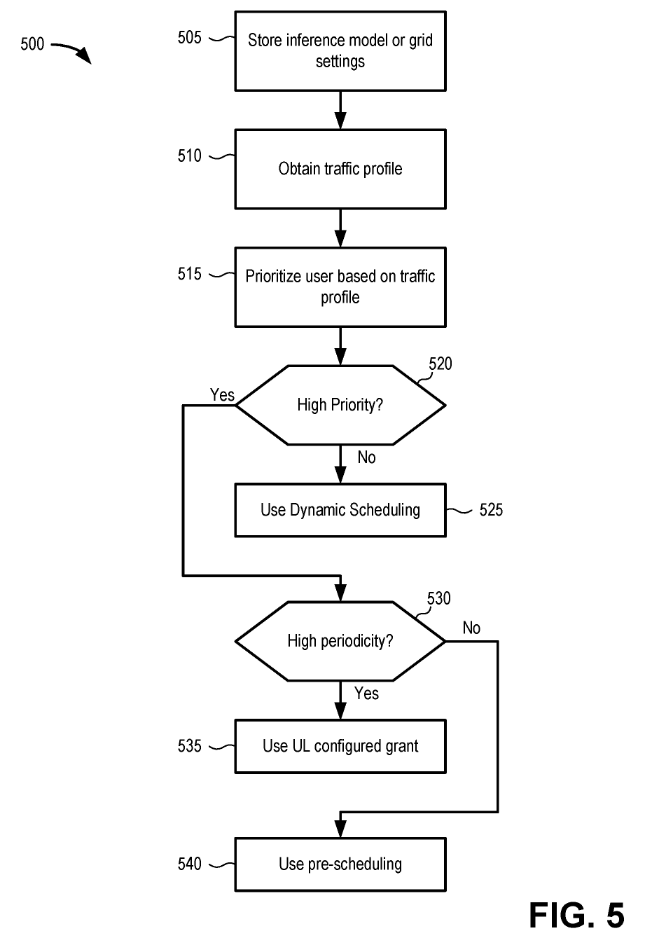

FIG. 5 is a diagram illustrating an exemplary process 500 of an embodiment of the adaptive UL grant service. According to this example, process 500 may be implemented by an access device 215. According to exemplary embodiment, access device 215 may be implemented as a gNB (e.g., integrated or split), CU 330 and a DU 340 within a gNB, for example. In other implementations, some or all of process 500 may be implemented by a RIC or another access device 215. For simplicity, description of FIG. 5 refers to actions by DU 340.

At block 505, DU 340 may store an inference model or grid/table for adaptive UL grants. For example, DU 340 may receive an inference model (e.g., inference model 415) from AI/ML optimization engine 260. Alternatively, DU 340 may store a grid/table that correlates certain traffic patterns to different UL scheduling parameters. At block 510, DU 340 may obtain a traffic profile for an end device. For example, as part of an attachment and/or session establishment process, DU 340 may identify a device type, an application type, and/or RF conditions for a requested session.

At block 515, DU 340 may prioritize the user based on the traffic profile. For example, DU 340 may assign end device 250 into one of two groups, a low priority group or a high priority group, based on the latency sensitivity priority score and/or RF conditions for the session. For example, end devices with predicted traffic patterns indicating high latency sensitivity, normal or smaller data sizes, and good RF conditions may be assigned to the high priority pool. Conversely, end devices with predicted traffic patterns indicating high latency sensitivity, but with poor RF conditions or large data sizes, may be assigned to the low priority pool.

If the user is not assigned high priority (block 520 – No), at block 525, DU 340 may use dynamic scheduling. For example, DU 340 may apply dynamic scheduling upon receiving an SR or BSR from end device 250.

If the user is assigned high priority (block 520 – Yes), at block 530, DU 340 may determine if the projected traffic pattern has high periodicity. For example, based on the application type, device type, assigned network slice, etc., DU 340 may determine that end device 250 may receive UL pre-grants (e.g., UL grants before receiving an SR or BSR). DU 340 may determine whether the type of UL traffic from end device 250 is most likely to be (a) periodic with predictable bursts or (b) less predictable and sporadic. For example, some applications, such as maps and single-player games may have regular, consistent trends for UL data (i.e., high periodicity). Other applications, such as augmented reality and interactive multi-player games, may have predictable, but irregular UL data loads (i.e., not high periodicity).

If the projected traffic pattern has high periodicity (block 530 – Yes), at block 535, DU 340 may use an adapted UL configured grant to assign resources. For example, DU 340 may assign periodic grants configured with a PRB size, MCS scheme, and periodicity most closely matched to a predicted traffic pattern (from inference model 415) for the corresponding end device 250.

If the projected traffic pattern does not have high periodicity (block 530 – No), at block 540, DU 340 may use a pre-scheduling to assign UL resources. For example, DU 340 may pre-schedule grants with a PRB size, number of PRBs, and periodicity most closely matched to a predicted traffic pattern (from inference model 415) for the corresponding end device 250.

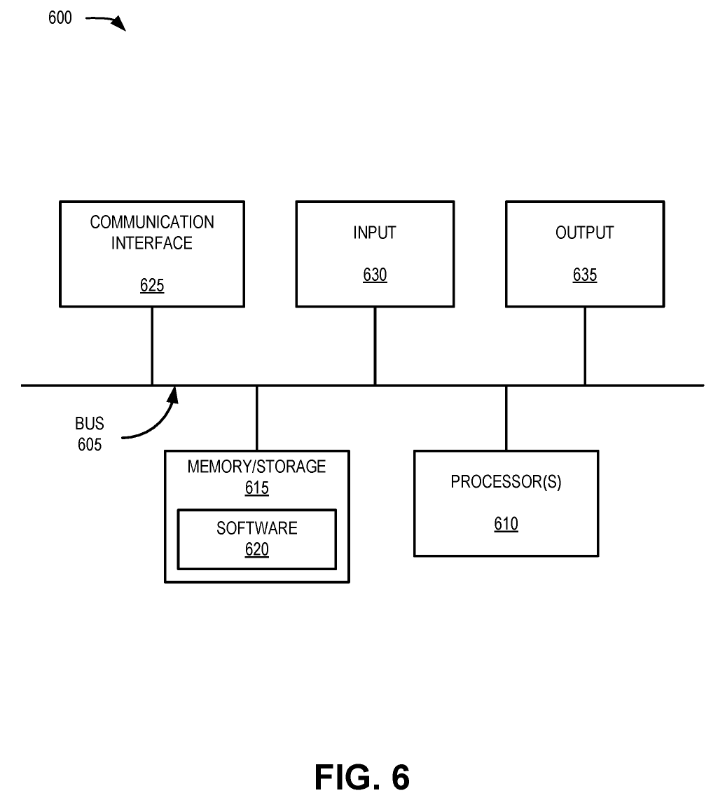

FIG. 6 is a diagram illustrating exemplary components of a device 600 that may be included in one or more of the devices described herein. For example, device 600 may correspond to access device 215, core device 225, external device 235, end device 250, CU 330, DU 340, and/or other types of network devices, as described herein. As illustrated in FIG. 6, device 600 includes a bus 605, a processor 610, a memory/storage 615 that stores software 620, a communication interface 625, an input 630, and an output 635. According to other embodiments, device 600 may include fewer components, additional components, different components, and/or a different arrangement of components than those illustrated in FIG. 6 and described herein.

Bus 605 includes a path that permits communication among the components of device 600. For example, bus 605 may include a system bus, an address bus, a data bus, and/or a control bus. Bus 605 may also include bus drivers, bus arbiters, bus interfaces, clocks, and so forth.

Processor 610 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 610 may be implemented as hardware (e.g., a microprocessor, etc.), a combination of hardware and software (e.g., a SoC, an ASIC, etc.), may include one or multiple memories (e.g., cache, etc.), etc.

Processor 610 may control the overall operation, or a portion of operation(s) performed by device 600. Processor 610 may perform one or multiple operations based on an operating system and/or various applications or computer programs (e.g., software 620). Processor 610 may access instructions from memory/storage 615, from other components of device 600, and/or from a source external to device 600 (e.g., a network, another device, etc.). Processor 610 may perform an operation and/or a process based on various techniques including, for example, multithreading, parallel processing, pipelining, interleaving, learning, model-based, etc.

Memory/storage 615 includes one or multiple memories and/or one or multiple other types of storage mediums. For example, memory/storage 615 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory, a solid state memory, and/or some other type of memory. Memory/storage 615 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 615 may be external to and/or removable from device 600, such as, for example, a Universal Serial Bus (USB) memory stick, a dongle, a hard disk, mass storage, off-line storage, or some other type of storing medium. Memory/storage 615 may store data, software, and/or instructions related to the operation of device 600.

Software 620 includes an application or a program that provides a function and/or a process. As an example, with reference to DU 340, software 620 may include an application that, when executed by processor 610, provides a function and/or a process of the adaptive UL grant service, as described herein. According to another example, with reference to AI/ML optimization engine 260, software 620 may include an application that, when executed by processor 610, provides a modeling function and/or a process of the adaptive UL grant service, as described herein. Software 620 may also include firmware, middleware, microcode, hardware description language (HDL), and/or another form of instruction. Software 620 may also be virtualized. Software 620 may further include an operating system (OS) (e.g., Windows, Linux, Android, proprietary, etc.).

Communication interface 625 permits device 600 to communicate with other devices, networks, systems, and/or the like. Communication interface 625 includes one or multiple wireless interfaces, optical interfaces, and/or wired interfaces. For example, communication interface 625 may include one or multiple transmitters and receivers, or transceivers. Communication interface 625 may operate according to a protocol stack and a communication standard.

Input 630 permits an input into device 600. For example, input 630 may include a keyboard, a mouse, a display, a touchscreen, a touchless screen, a button, a switch, an input port, speech recognition logic, and/or some other type of visual, auditory, tactile, affective, olfactory, etc., input component. Output 635 permits an output from device 600. For example, output 635 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 600 may be implemented in the same manner. For example, device 600 may be instantiated, created, deleted, or some other operational state during its life cycle (e.g., refreshed, paused, suspended, rebooted, or another type of state or status), using well-known virtualization technologies. For example, access device 215, core device 225, external device 235, and/or another type of network device or end device 250, as described herein, may be a virtualized device.

Device 600 may be configured to perform a process and/or a function, as described herein, in response to processor 610 executing software 620 stored by memory/storage 615. By way of example, instructions may be read into memory/storage 615 from another memory/storage 615 (not shown) or read from another device (not shown) via communication interface 625. The instructions stored by memory/storage 615 may configure device 600 and/or cause processor 610 to perform a function or a process described herein. Alternatively, for example, according to other implementations, device 600 may be configured to perform a function or a process described herein based on the execution of hardware (processor 610, etc.).

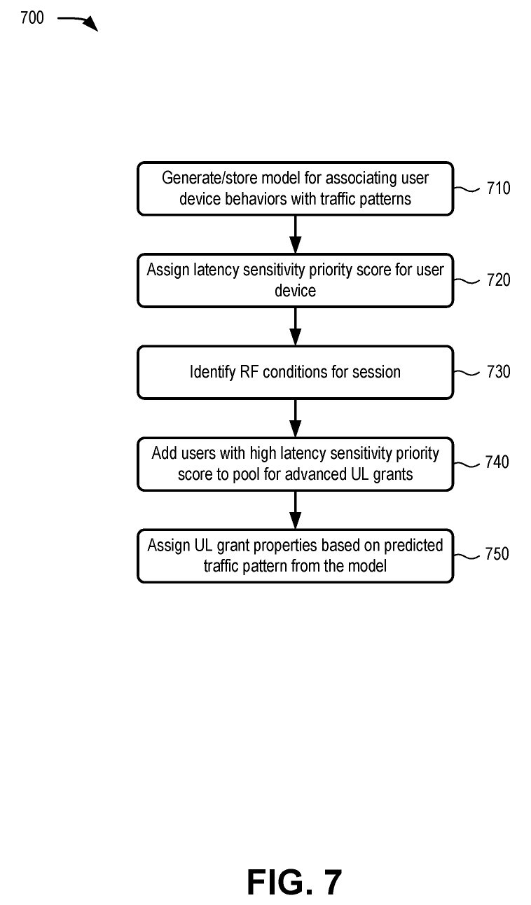

FIG. 7 is a flow diagram illustrating an exemplary process 700 of an exemplary embodiment of the adaptive UL grant service. According to an exemplary embodiment, process 700 may be implemented by access device 215 (e.g., CU 330 or DU 340). According to an exemplary implementation, a processor may execute software to perform a step (in whole or in part) of process 700, as described herein. Alternatively, a step (in whole or in part) may be performed by execution of only hardware.

Process 700 may include generating and/or storing a model for associating traffic patterns with user applications (block 710). For example, access device 215 may receive and store a model (e.g., inference model 415) from AI/ML optimization engine 260. The model may include predicted traffic patterns associated with user devices. In one implementation, the model may include predicted traffic patterns of user devices using particular applications within a cell of access device 215.

Process 700 may further include assigning a latency sensitivity priority score for a user (block 720) and identifying RF conditions for a new user session (block 730). For example, access device 215 may assign a latency sensitivity priority score for an end device based on the inference model 415. For example, access device 215 may associate a device ID and/or application type for end device 250 with a predicted traffic pattern from inference model 415. The latency sensitivity priority score may provide an indication of the importance of low latency communications for a user session with the predicted traffic pattern. Access device 215 may also identify current RF conditions for the end device, such as signal quality parameters described above in connection with inference data 426 of FIG. 4.

Process 700 may also include adding users with a high latency sensitivity priority score to a pool for advanced UL grants (block 740). For example, when the predicted traffic pattern associated with the user device matches a high latency sensitive pattern in the inference model and the identified RF conditions are above a good RF condition threshold (e.g., RF levels that can support low latency communications for the predicted traffic pattern, as established by AI/ML optimization engine 260 or a network operator), access station 215 may add the user device to a pool for advanced UL grants. In other implementation, access device 215 may also limit access to the pool of end devices 250 whose traffic size is within predefined threshold and whose burstiness shows more predictable trends. In still other implementation, no end devices 250 may be included in the pool for advanced UL grants if the is network congestion. That is, when the network is in a congestion situation, a dynamic grant may be preferred to maximize network spectrum efficiency.

Process 700 may also include assigning UL grant properties for the user device based on a predicted traffic pattern from the model (block 750). For example, for end devices 250 assigned to the pool for advanced UL grants, access device 215 may adjust the UL grants properties for individual end devices 250, including, for example the PRB size, an MCS table to be used, and/or the periodicity/offset.

A method, a network device, and a non-transitory computer-readable storage medium are described in relation to an adaptive UL grant service. The service assigns a latency sensitivity priority score for a user device based on the model and identifies a radio frequency (RF) condition for the user device. The service also adds the user device to a pool for advanced UL grants based on the latency sensitivity priority score, when the identified RF conditions are above an RF condition threshold. The service assigns prior to receiving a scheduling request from the user device, UL grant properties for the user device in the pool based on a predicted traffic pattern from the model.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of blocks have been described regarding the processes illustrated in FIG. 5 and 7, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 610, etc.), or a combination of hardware and software (e.g., software 620).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 610) of a device. A non-transitory storage medium includes one or more of the storage mediums described in relation to memory/storage 615. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such. All structural and functional equivalents to the elements of the various aspects set forth in this disclosure that are known or later come to be known are expressly incorporated herein by reference and are intended to be encompassed by the claims.

What is claimed is:

1. A method comprising:
storing, by a network device in a radio access network (RAN), a model for associating user devices with predicted traffic patterns;
assigning, by the network device, a latency sensitivity priority score for a user device based on the model;
identifying, by the network device, a radio frequency (RF) condition for the user device;
adding, by the network device, the user device to a first pool for advanced uplink (UL) grants based on the latency sensitivity priority score, when the identified RF conditions are above an RF condition threshold; and
assigning, by the network device and prior to receiving a scheduling request from the user device, UL grant properties for the user device in the first pool based on a predicted traffic pattern from the model.

2. The method of claim 1, further comprising:
adding the user device to a second pool for dynamic grants when the identified RF conditions are at or below the RF condition threshold.

3. The method of claim 1, further comprising:
generating the model based on historical traffic pattern data associated with users in a cell serviced by the network device.

4. The method of claim 1, wherein assigning the UL grant properties includes adapting one or more of a grant size, a periodicity, or a modulation coding scheme for the user device based on the predicted traffic patterns.

5. The method of claim 1, wherein assigning the latency sensitivity priority score includes:
assigning a higher priority component for an application that benefit from low latency.

6. The method of claim 1, wherein assigning the UL grant properties includes:
assigning a UL configured grant when the predicted traffic patterns have likely periodicity, and
assigning UL pre-scheduling when the predicted traffic patterns do not indicate likely periodicity.

7. The method of claim 1, wherein assigning the UL grant properties for the user device include:
adjusting a grant periodicity and offset based on a grant-to-data-arrival time from the predicted traffic pattern.

8. The method of claim 1, wherein the network device in a wireless access station of the RAN.

9. A network device comprising:
a processor, wherein the processor is configured to:
store a model for associating user devices with predicted traffic patterns;
assign a latency sensitivity priority score for a user device based on the model;
identify a radio frequency (RF) condition for the user device;
add the user device to a first pool for advanced uplink (UL) grants based on the latency sensitivity priority score, when the identified RF conditions are above an RF condition threshold; and
assign, prior to receiving a scheduling request from the user device, UL grant properties for the user device in the first pool based on a predicted traffic pattern from the model.

10. The network device of claim 9, wherein the processor is further configured to:
add the user device to a second pool for dynamic grants when the identified RF conditions are at or below the RF condition threshold.

11. The network device of claim 9, wherein the model includes a table of traffic pattern data associated with user devices and application types.

12. The network device of claim 9, wherein, when assigning the UL grant properties, the processor is further configured to:
adapt one or more of a grant size and number of physical resource blocks to match a burst size for the user device based on the predicted traffic pattern.

13. The network device of claim 10, wherein, when assigning the UL grant properties, the processor is further configured to:
adjust a modulation coding scheme for the user device based on the identified RF conditions.

14. The network device of claim 10, wherein, when assigning the UL grant properties, the processor is further configured to:
adjust a grant periodicity or offset for the user device based on the predicted traffic pattern.

15. The network device of claim 10, wherein, when assigning the latency sensitivity priority score, the processor is further configured to:
assigning a higher priority component for an application that benefit from low latency.

16. The network device of claim 10, wherein the network device is a Distributed Unit (DU) of a Radio Access Network (RAN).

17. A non-transitory computer-readable storage medium storing instructions executable by a processor of a network device, wherein the instructions are configured to:
store a model for associating user devices with predicted traffic patterns;
assign a latency sensitivity priority score for a user device based on the model;
identify a radio frequency (RF) condition for the user device;
add the user device to a first pool for advanced uplink (UL) grants based on the latency sensitivity priority score, when the identified RF conditions are above an RF condition threshold; and
assign, prior to receiving a scheduling request from the user device, UL grant properties for the user device in the first pool based on a predicted traffic pattern from the model.

18. The non-transitory computer-readable storage medium of claim 17, wherein the instructions are further configured to:
add the user device to a second pool for dynamic grants when the identified RF conditions are at or below the RF condition threshold.

19. The non-transitory computer-readable storage medium of claim 17, wherein the instructions to assign the UL grant properties are further configured to:
adapt one or more of a grant size and number of physical resource blocks to match a burst size for the user device based on the predicted traffic pattern; and
adjust an offset for the user device based on the predicted traffic pattern.

20. The non-transitory computer-readable storage medium of claim 17, wherein the instructions to assign the UL grant properties are further configured to:
adjust a modulation coding scheme for the user device based on the identified RF conditions.
